(19) United States
(12) Patent Application Publication
(10) Pub. No.: US 2009/0190361 A1
(43) Pub. Date: Jul. 30, 2009

(54) Assembly structure of the reflector plate

(76) Inventor: Hung-Huei Chung, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/003,400

(22) Filed: Dec. 26, 2007

(51) Int. Cl. F21V 7/00

(52) U.S. Cl. 362/341

(57) ABSTRACT

An assembly structure of the reflector plate, especially indicates a structure which can be enveloped on the exterior of lamps in the Christmas lamp strings, to provide better light effects of reflection and blinking and form integrated assembly products rich of decoration effects. The structure is mainly including a fixing clamp, an assembling frame and a reflector plate, which utilizes the fixing clamp to fix the frame and reflector to other shaped products, and uses the assembling frame to be adjustable fixed to the fixing frame. The structure also provides the enveloped lamp groups and combined with reflector plate to adjust the assembling locations and obtain the excellent reflection and lighting effect that can conform to the expected objects of this invention.

### BACKGROUND OF THE INVENTION

The former decoration lamp strings mainly utilizes each lamp provided light to become the light source for decoration usage. This light is normally fixed and unchanged thus is more bleak. Therefore, there are known to add the reflector plates to the exterior or surrounding of lamps, for example in the cases of American patent application Ser. Nos. 11/599,314 and 11/512,280. Although the aforementioned cases can reach partial effects, the reflector plate will be clamped and not be able to swing under certain specific angles due to the fixing structure of its reflector plate. This will result in the loss of flashing effect of light reflection, and thus still have the points to be improved.

### SUMMARY OF THE INVENTION

The main object of this invention is to provide an assembly structure having the adjustability to locate the reflector plate to the most appropriate positions to fit the lamps, and thus achieve the best flashing light effects. The present invention will be described hereafter by referring to drawings.

### BRIEF DESCRIPTION OF THE DRAWINGS

FIG. 1 is a three-dimensional analytic drawing of the present invention.

FIG. 2 is a three-dimensional assembly drawing of the present invention.

FIGS. 3 and 4 are application drawings of assembly embodiments of the present invention.

FIGS. 5 and 6 are explanatory motion drawings of rotating assembly frames the present invention.

### DETAILED DESCRIPTION OF THE PREFERRED EMBODIMENT

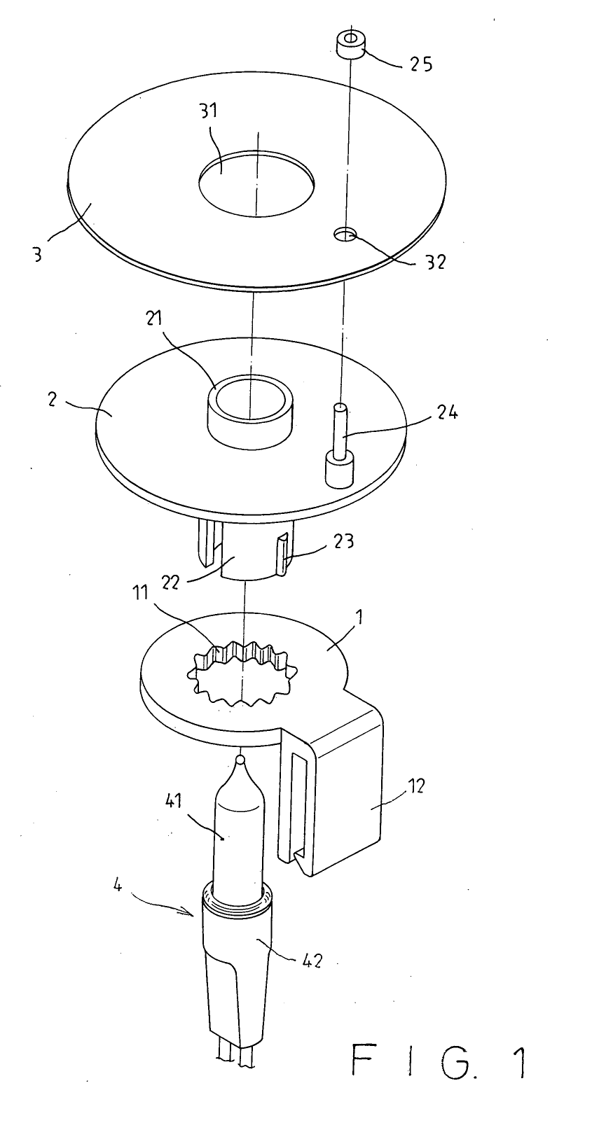

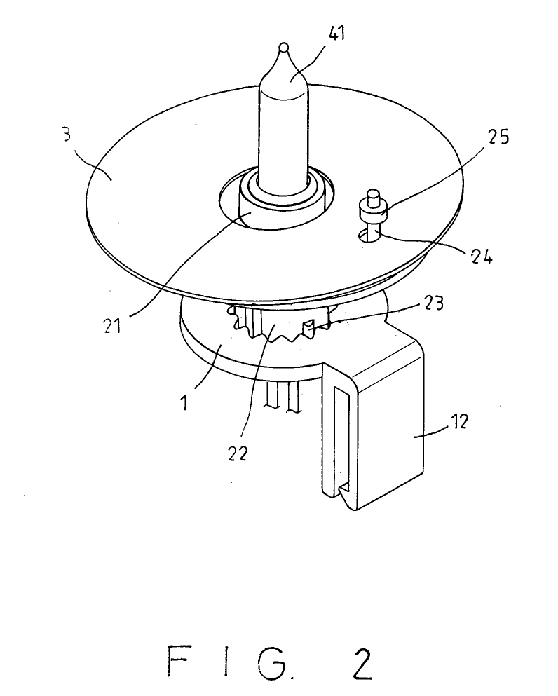

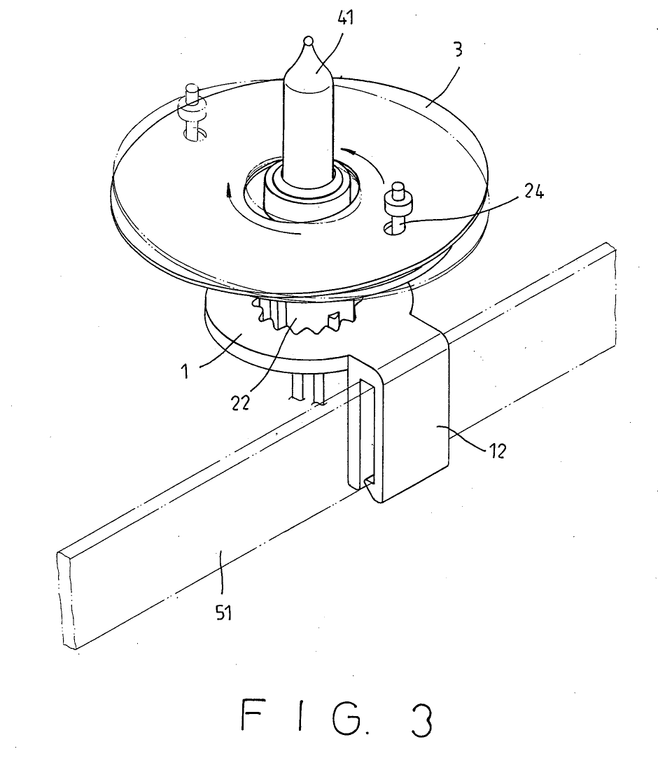

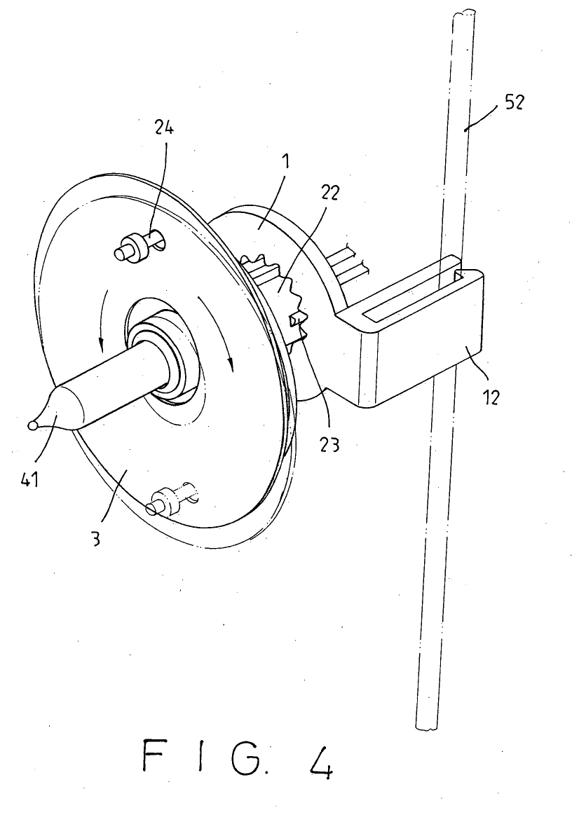

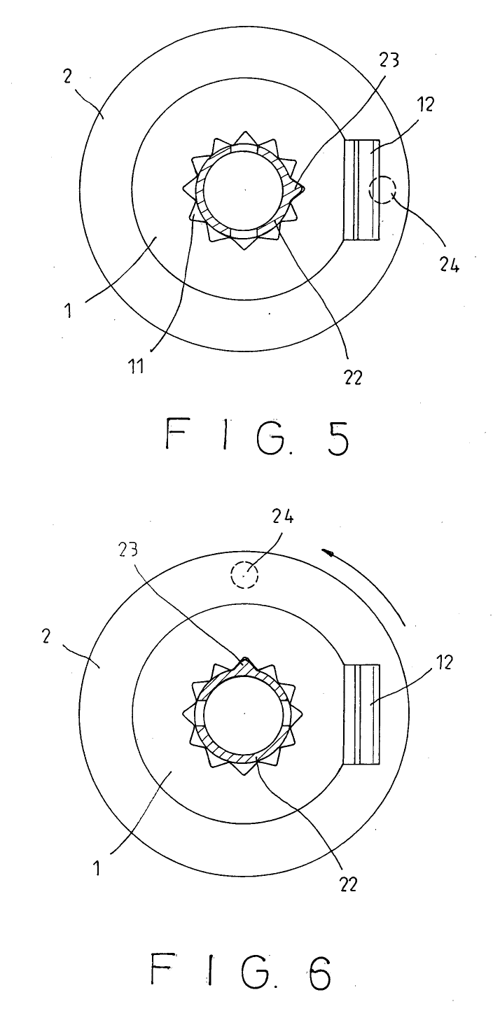

Please refer to FIGS. 1 and 2. The present invention includes a fixing frame (1), an assembling frame (2) and a reflector plate (3), wherein the fixing frame (1) has a tooth shaped assembly hole (11) set with an elastic clamp (12) in one side the upper center portion of the assembling frame (2) sets with a sleeve ring (21) to envelope a lamp group and position the lamp above the ring. Two opposite C shaped plates (22) having a gap in between are set in the lower portion, and have the elasticity to incline toward to the middle.

A protruded block (23) is set in the exterior of one or two of the C shaped plates (22). An integration structure is thus formed with the elastic assembly of the fixing frame (1) and assembling frame (2) by clamping in the two C shaped plates (22) to the tooth shaped assembling hole (11) and the clamping fit of this protruded block (23) with the concaved portion. A protruding rod (24) that is small at top and big at bottom is set in the upper side of the assembling frame (2). The reflector (3) has center hole (31) whose inner diameter is larger than that of the sleeve ring (21) in the assembling frame (2). The side of the reflector opposite to the protruding rod (24) is set with an open hole (32) whose inner diameter is larger than that of a thinner end of the protruding rod but smaller than that of a thicker end of the protruding rod. Therefore, the reflector (3) can form a loosen assembly status with the assembling frame (2) by enveloping the open hole (32) on top of the protruding rod (24) and using a positioning fixing ring (25) to fasten to the utmost end in the protruding rod (24).

The present invention can provide anyone lamp string (4) a way to pass through while usage thus allow the lamp (41) to pass through two C shaped plates (22) and be exposed on top of the reflector plate (3). And the lamp seat (42) will be just enveloped by sleeve ring (21). Furthermore, the lamp groups (4) can be fix to that position by utilizing the elastic clamp (12) of a fixing frame (1) randomly being clamp-fit to the supporting frames of different shaped products. Each lamp group can be easily clamp-fit to supporting frames of any shapes of decoration while every lamp groups are all assembled with the assembly structures of the reflector plates of the present invention. Thus, this model can be equipped with decoration effect of lighting. If any one of the reflector (3) may be or bad angled or clamped and unable to swing, the present invention can rotate the assembling frame (2) directly to change the relative clamp-fit location of the protruding block (23) located outside of the C shaped plates (22) with the tooth shaped assembling hole (11). By referring to the drawings 5 and 6 and changing the position of protruding rod (24), the reflector plate (3) can form a hanging status which can swing. This can assure the reflector plate (3) to elaborate the best effects of its blinking reflecting light thus can overcome the weakness of the known embodiments.

I claim:

1. An assembly structure of the reflector plate being possibly enveloped on the exterior of lamp groups including a fixing fame, an assembling frame and a reflector plate, wherein the assembling frame has a tooth shaped assembly hole set with an elastic clamp in one side the upper center portion of the assembling frame sets with a sleeve ring to envelope a lamp group and position the lamp above the ring, two opposite C shaped plates having a gap in between are set in the lower portion, and have the elasticity to incline toward to the middle; a protruded block set in the exterior of one or two of the C shaped plates, an integration structure being thus formed with the elastic assembly of the fixing frame and assembling frame by clamping in the two C shaped plates to the tooth shaped assembling hole and the clamping fit of this protruded block with the concaved portion, a protruding rod that is small at top and big at bottom is set in the upper side of the assembling frame, the reflector having center hole whose inner diameter is larger than that of the sleeve ring in the assembling frame, the side of the reflector opposite to the protruding rod being set with an open hole whose inner diameter is larger than that of a thinner end of the protruding rod but smaller than that of a thicker end of the protruding rod, becoming a loosen assembly status with the assembling frame by enveloping the open hole on top of the protruding rod and using a fixing ring to fasten to the utmost end in the protruding rod.
